(19) United States
(12) Patent Application Publication
(10) Pub. No.: US 2016/0139763 A1
(43) Pub. Date: May 19, 2016

(54) SYLLABARY-BASED AUDIO-DICTIONARY FUNCTIONALITY FOR DIGITAL READING CONTENT

(71) Applicant: Kobo Inc., Toronto (CA)

(72) Inventors: Chelsea Phelan-Tran, Ajax (CA); Benjamin Landau, Toronto (CA)

(21) Appl. No.: 14/546,469

(22) Filed: Nov. 18, 2014

(51) Int. Cl. G06F 3/0488; G06F 17/30; G06F 3/0483

(52) U.S. Cl. CPC G06F 3/0488; G06F 3/0483; G06F 17/30392

(57) ABSTRACT

A computing device includes a housing and a display assembly having a screen and a set of touch sensors. The housing at least partially circumvents the screen so that the screen is viewable. A processor is provided within the housing to display content pertaining to an e-book on the screen of the display assembly. The processor further detects a first user interaction with the set of touch sensors and interprets the first user interaction as a first user input corresponding with a selection of a first portion of an underlying word in the displayed content. The processor then displays syllabary content for at least the first portion of the underlying word.

### TECHNICAL FIELD

Examples described herein relate to a computing device that provides syllabary content to a user reading an e-book.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

Some electronic personal display devices are purpose built devices that are designed to perform especially well at displaying readable content. For example, a purpose built purpose build device may include a display that reduces glare, performs well in high lighting conditions, and/or mimics the look of text on actual paper. While such purpose built devices may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links a device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for utilizing applications and providing e-book services on a computing device, according to an embodiment.

FIG. 2 illustrates an example of an e-reading device or other electronic personal display device, for use with one or more embodiments described herein.

FIG. 3 illustrates an embodiment of an e-reading device that responds to user input by providing syllabary content for a word associated with the user input.

FIGS. 4A-4C illustrate embodiments of an e-reading device that responds to user input by providing syllabary content for one or more portions of a word associated with the user input.

FIG. 5 illustrates an e-reading system for displaying e-book content, according to one or more embodiments.

FIG. 6 illustrates a method of providing syllabary content for one or more portions of a word contained in an e-book being read by a user, according to one or more embodiments.

### DETAILED DESCRIPTION

Embodiments described herein provide for a computing device that provides syllabary content for one or more portions of a word contained in an e-book being read by a user. The user may select the word, or portions thereof, from e-book content displayed on the computing device, for example, by interacting with one or more touch sensors provided with a display assembly of the computing device. The computing device may then display syllabary content (e.g., from a syllable-based audio dictionary) pertaining to the selected portion(s) of the corresponding word.

According to some embodiments, a computing device includes a housing and a display assembly having a screen and a set of touch sensors. The housing at least partially circumvents the screen so that the screen is viewable. A processor is provided within the housing to display content pertaining to an e-book on the screen of the display assembly. The processor further detects a first user interaction with the set of touch sensors and interprets the first user interaction as a first user input corresponding with a selection of a first portion of an underlying word in the displayed content. The processor then displays syllabary content for at least the first portion of the underlying word.

The selected portion of the underlying word may comprise a string of one or more characters or symbols. In particular, the selected portion may coincide with one or more syllables of the underlying word. For some embodiments, the processor may play back audio content including a pronunciation of the one or more syllables. Further, for some embodiments, the processor may search a dictionary using the underlying word as a search term. For example, the dictionary may be a syllable-based audio dictionary. The processor may then determine a syllabary representation of the underlying word based on a result of the search. Further, the processor may parse the syllabary content for the first portion of the underlying word from the syllabary representation of the underlying word.

For some embodiments, the processor may detect a second user interaction with the set of touch sensors and interpret the second user interaction as a second user input corresponding with a selection of a second portion of underlying word. Specifically, the second portion of the underlying word may be different than the first portion. The processor may then display syllabary content for the second portion of the underlying word with the syllbary content for the first portion. For example, the first portion may coincide with a first syllable of the underlying word whereas the second portion coincides with a second syllable of the underlying word. For some embodiments, the processor may further play back audio content including a pronunciation of the first syllable and the second syllable. Specifically, the first and second syllables may be pronounced in the order in which they appear in the underlying word.

Among other benefits, examples described herein provide an enhanced reading experience to users of e-reader devices (or similar computing devices that operate as e-reading devices). For example, the pronunciation logic disclosed herein may help users improve their literacy and/or learn new languages by breaking down words into syllables or phonemes. More specifically, the pronunciation logic allows users to view and/or hear the correct pronunciation of words while reading content that they enjoy. Moreover, by enabling the user to select individual syllabic portions of an underlying word, the embodiments herein may help the user understand the difference between syllables that are spelled the same but are pronounced differently.

“E-books” are a form of an electronic publication that can be viewed on computing devices with suitable functionality. An e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., e-reading apps) to view e-books. Still further, some devices (sometimes labeled as “e-readers”) can be centric towards content viewing, and e-book viewing in particular.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic. As used herein, the term “syllabary” refers to any set of characters representing syllables. For example, “syllabary content” may be used to illustrate how a particular syllable or string of syllables is pronounced or vocalized for a corresponding word.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

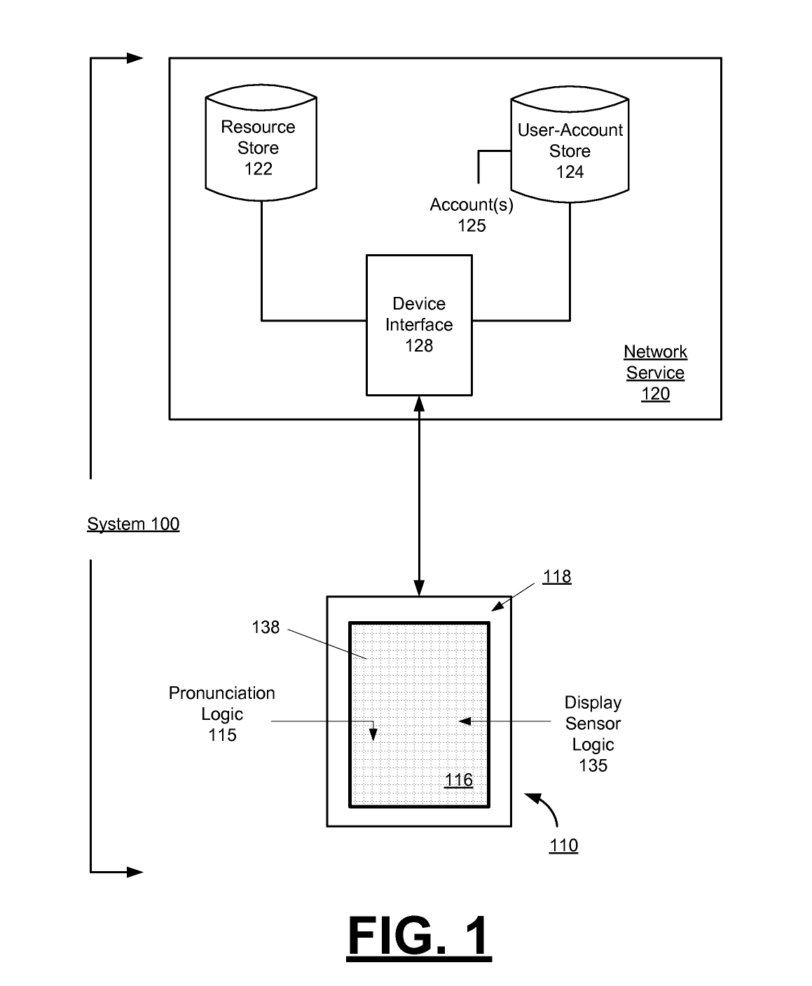

FIG. 1 illustrates a system 100 for utilizing applications and providing e-book services on a computing device, according to an embodiment. In an example of FIG. 1, system 100 includes an electronic display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services which communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reading application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116 and a housing 118. In an embodiment, the display screen 116 is touch-sensitive, to process touch inputs including gestures (e.g., swipes). For example, the display screen 116 may be integrated with one or more touch sensors 138 to provide a touch sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, the housing 118 can also be integrated with touch sensors to provide one or more touch sensing regions, for example, on the bezel and/or back surface of the housing 118.

According to some embodiments, the e-reading device 110 includes display sensor logic 135 to detect and interpret user input made through interaction with the touch sensors 138. By way of example, the display sensor logic 135 can detect a user making contact with the touch sensing region of the display 116. For some embodiments, the display sensor logic 135 may interpret the user contact as a type of user input corresponding with the selection of a particular word, or portion thereof (e.g., syllable), from the e-book content provided on the display 116. For example, the selected word and/or syllable may coincide with a touch sensing region of the display 116 formed by one or more of the touch sensors 138. The user input may correspond to, for example, a tap-and-hold input, a double-tap input, or a tap-and-drag input.

In some embodiments, the e-reading device 110 includes features for providing functionality related to displaying e-book content. For example, the e-reading device can include pronunciation logic 115, which provides syllabary content for a selected word and/or syllable contained in an e-book being read by the user. Upon detecting a user input corresponding with the selection of a particular word or syllable, the word discovery logic 115 may display a pronunciation guide for the selected word or syllable. Specifically, the pronunciation guide may be displayed in a manner that does not detract from the overall reading experience of the user. For example, the pronunciation guide may be presented as an overlay for the e-book content already on screen (e.g., displayed at the top or bottom portion of the screen). For some embodiments, the pronunciation logic 115 may play back audio content including a pronunciation of the selected word or syllable. Further, for some embodiments, the pronunciation logic 115 may allow the user to select multiple syllables (e.g., in succession) to gradually construct (or deconstruct) the pronunciation of the underlying word. This allows the user to learn the proper pronunciation of individual syllables (e.g., and not just the entire word) to help the user understand how to pronounce similar-sounding words and/or syllables and further the user's overall reading comprehension.

The pronunciation logic 115 can be responsive to various kinds of interfaces and actions in order to enable and/or activate the pronunciation guide. In one implementation, a user can select a desired word or syllable by interacting with the touch sensing region of the display 116. For example, the user can select a particular word by tapping and holding (or double tapping) a region of the display 116 coinciding with that word. Further, the user can select a portion of the word (e.g., including one or more syllables) by tapping a region of the display 116 coinciding with the beginning of the desired portion and, without releasing contact with the display surface, dragging the user's finger to another region of the display 116 coinciding with the end of the desired portion.

Hardware Description

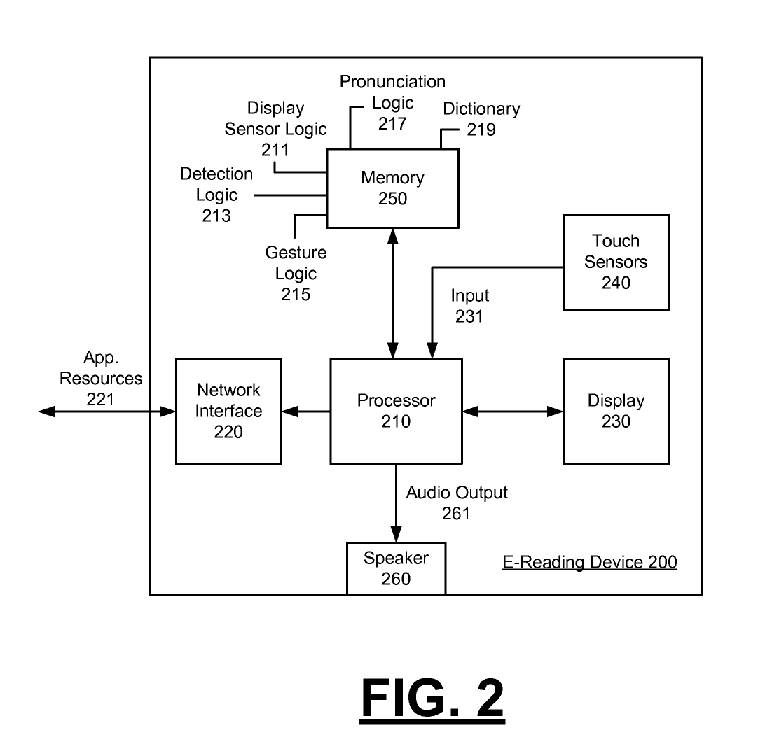

FIG. 2 illustrates an example of an e-reading device 200 or other electronic personal display device, for use with one or more embodiments described herein. In an example of FIG. 2, an e-reading device 200 can correspond to, for example, the device 110 as described above with respect to FIG. 1. With reference to FIG. 2, e-reading device 200 includes a processor 210, a network interface 220, a display 230, one or more touch sensor components 240, a memory 250, and an audio output device (e.g., speaker) 260.

The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources 221, such as e-books or media files, that the user elects to purchase or otherwise download from the network service 120. The application resources 221 that are downloaded onto the e-reading device 200 can be stored in the memory 250.

In some implementations, the display 230 can correspond to, for example, a liquid crystal display (LCD), an electrophoretic display (EPD), or a light emitting diode (LED) display that illuminates in order to provide content generated from processor 210. In some implementations, the display 230 can be touch-sensitive. For example, in some embodiments, one or more of the touch sensor components 240 may be integrated with the display 230. In other embodiments, the touch sensor components 240 may be provided (e.g., as a layer) above or below the display 230 such that individual touch sensor components 240 track different regions of the display 230. Further, in some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the touch sensor components 240, the display 230, and/or other input mechanisms (e.g., buttons, keyboard, mouse, microphone, etc.). With reference to examples described herein, the processor 210 can respond to input 231 from the touch sensor components 240. In some embodiments, the processor 210 responds to inputs 231 from the touch sensor components 240 in order to facilitate or enhance e-book activities such as generating e-book content on the display 230, performing page transitions of the e-book content, powering off the device 200 and/or display 230, activating a screen saver, launching an application, and/or otherwise altering a state of the display 230.

In some embodiments, the memory 250 may store display sensor logic 211 that monitors for user interactions detected through the touch sensor components 240 provided with the display 230, and further processes the user interactions as a particular input or type of input. In an alternative embodiment, the display sensor logic 211 may be integrated with the touch sensor components 240. For example, the touch sensor components 240 can be provided as a modular component that includes integrated circuits or other hardware logic, and such resources can provide some or all of the display sensor logic 211 (see also display sensor logic 135 of FIG. 1). For example, integrated circuits of the touch sensor components 240 can monitor for touch input and/or process the touch input as being of a particular kind. In variations, some or all of the display sensor logic 211 may be implemented with the processor 210 (which utilizes instructions stored in the memory 250), or with an alternative processing resource.

In one implementation, the display sensor logic 211 includes detection logic 213 and gesture logic 215. The detection logic 213 implements operations to monitor for the user contacting a surface of the display 230 coinciding with a placement of one or more touch sensor components 240. The gesture logic 215 detects and correlates a particular gesture (e.g., pinching, swiping, tapping, etc.) as a particular type of input or user action. In some embodiments, the gesture logic 215 may associate the user input with a word or syllable from the e-book content coinciding with a particular touch sensing region of the display 230. For example, the gesture logic 215 may associate a tapping input (e.g., tap-and-hold or double-tap) with a word coinciding with the touch sensing region being tapped. Alternatively, and/or in addition, the gesture logic 215 may associate a tap-and-drag input with a portion of a word (e.g., including one or more syllables) swiped over by the user. The selected word, or portion thereof, may comprise any string of characters and/or symbols (e.g., including punctuation marks, mathematical and/or scientific symbols).

The memory 250 further stores pronunciation logic 217 to provide syllabary content for a selected word and/or syllable associated with the user input. For example, the user input (e.g., a “syllabary selection input”) may correspond with the selection of a particular word, or one or more syllables of a word, from an e-book being read by the user. Upon detecting the user input, the pronunciation logic 217 may display syllabary content (e.g., in the form of a pronunciation guide) for the selected word or syllable(s). For some embodiments, the user may select multiple syllables of a word in succession. The pronunciation logic 217 may respond to each subsequent selection, for example, by stringing together syllabary content for multiple syllables in the order in which they appear in the underlying word. Further, for some embodiments, the pronunciation logic 217 may instruct the processor 210 to output audio content 261, via the speaker 260, which includes an audible pronunciation of each selected word and/or syllable.

For some embodiments, the pronunciation logic 217 may retrieve the syllabary content from a dictionary 219 stored in memory 250. Specifically, the dictionary 219 may be a syllable-based audio-dictionary that stores phonetic representations and/or audible pronunciations of words. For some embodiments, the pronunciation logic 217 may use the selected word, or the underlying word of a selected syllable, as a search term for searching the dictionary 219. The embodiments herein recognize that multiple syllables with the same spelling may have different pronunciations depending on the usage (e.g., depending on the underlying word). For example, the first syllable of demon ('dē-man) is pronounced differently than the first syllable of demonstrate ('dē-m [symbol] n-'strāt). Thus, the syllable “de” may have multiple pronunciations, depending on the context. By using the entire word as the search term, the pronunciation logic 217 may ensure that the proper syllabary content is retrieved for a particular syllable. For example, the pronunciation logic 217 may retrieve a syllabary representation of the underlying word (e.g., comprising a string of characters and/or phonemes) from the dictionary 219. The pronunciation logic 217 may then parse the syllabary content for the selected syllable(s) from the syllabary representation of the underlying word.

For other embodiments, the pronunciation logic 217 may send a search request to an external dictionary (e.g., residing on the network service 120) using the underlying word as the search term. For example, the external dictionary may be a web-based dictionary that is readily accessible to the public. Still further, for some embodiments, the pronunciation logic 217 may search multiple dictionaries (e.g., for different languages) and aggregate the syllabary content from multiple search results.

Word Pronunciation Guide

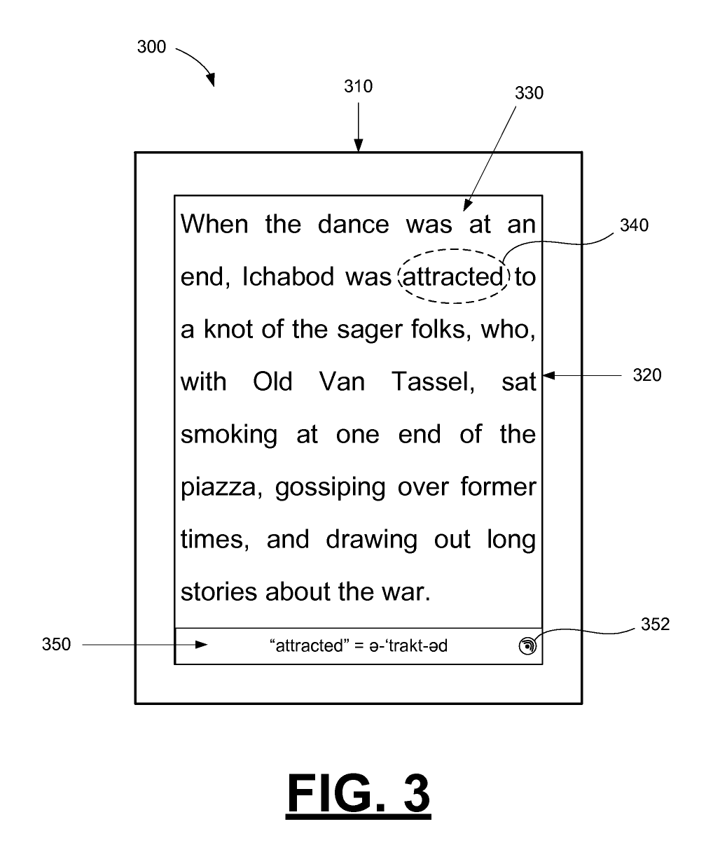

FIG. 3 illustrates an embodiment of an e-reading device that responds to user input by providing syllabary content for a word associated with the user input. The e-reading device 300 includes a housing 310 and a display screen 320. The e-reading device 300 can be substantially tabular or rectangular, so as to have a front surface that is substantially occupied by the display screen 320 so as to enhance content viewing. More specifically, the front surface of the housing 310 may be in the shape of a bezel surrounding the display screen 320. The display screen 320 can be part of a display assembly, and can be touch sensitive. For example, the display screen 320 can be provided as a component of a modular display assembly that is touch-sensitive and integrated with housing 310 during a manufacturing and assembly process.

A touch sensing region 330 is provided with at least a portion of the display screen 320. Specifically, the touch sensing region 330 may coincide with the integration of touch sensors with the display screen 320. For some embodiments, the touch sensing region 330 may substantially encompass a surface of the display screen 320. Further, the e-reading device 300 can integrate one or more types of touch-sensitive technologies in order to provide touch sensitivity on the touch sensing region 330 of the display screen 320. It should be appreciated that a variety of well-known touch sensing technologies may be utilized to provide touch-sensitivity, including, for example, resistive touch sensors, capacitive touch sensors (using self and/or mutual capacitance), inductive touch sensors, and/or infrared touch sensors.

For example, the touch-sensing feature of the display screen 320 can be employed using resistive sensors, which can respond to pressure applied to the surface of the display screen 320. In a variation, the touch-sensing feature can be implemented using a grid pattern of electrical elements which can detect capacitance inherent in human skin. Alternatively, the touch-sensing feature can be implemented using a grid pattern of electrical elements which are placed over or just beneath the surface of the display screen 320, and which deform sufficiently on contact to detect touch from an object such as a finger.

With reference to FIG. 3, e-book content pertaining to an “active” e-book (e.g., an e-book that the user is currently reading) is displayed on the display screen 320. For some embodiments, the e-reading device 300 may respond to user input received via the touch sensing region 330 by displaying a pronunciation guide 350 on the display screen 320. More specifically, the pronunciation guide 350 may include syllabary content for a selected word associated with the user input. For example, a user may select the word “attracted” by tapping-and-holding (or double-tapping) a region of the display 320 coinciding with that word. The e-reading device 300 may interpret this user input as a syllabary selection input 340. More specifically, upon detecting the syllabary selection input 340, the e-reading device 300 may search a dictionary for a syllabary representation (e.g., a string a phonemes that describes the proper pronunciation) of the selected word to be displayed in the pronunciation guide 350.

For some embodiments, the e-reading device 300 may also retrieve audio content including a pronunciation or vocalization of the selected word. For example, the user may tap an icon 352 provided in the pronunciation guide 350 to listen to an audible pronunciation of the selected word. The audible pronunciation may further aid the user in learning the proper pronunciation of words, as well as learn and/or interpret the phonemes displayed in the pronunciation guide 350 (e.g., “ [symbol] -'trakt- [symbol] d”).

It should be noted that the layout and content of the pronunciation guide 350 of FIG. 3 are described and illustrated for exemplary purposes only. In certain implementations, the pronunciation guide 350 may include fewer or more features than those shown in FIG.

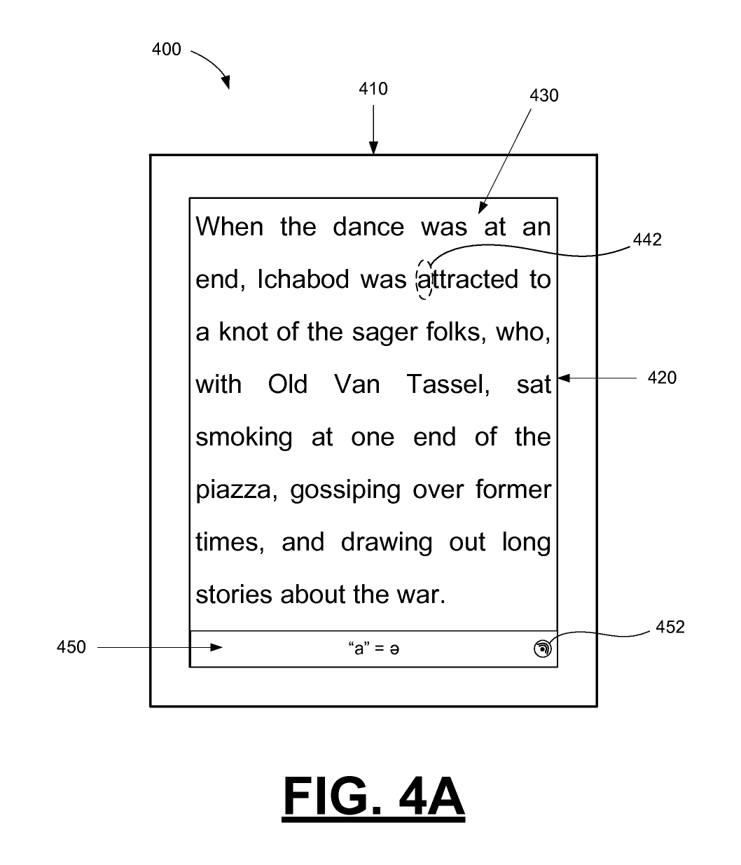

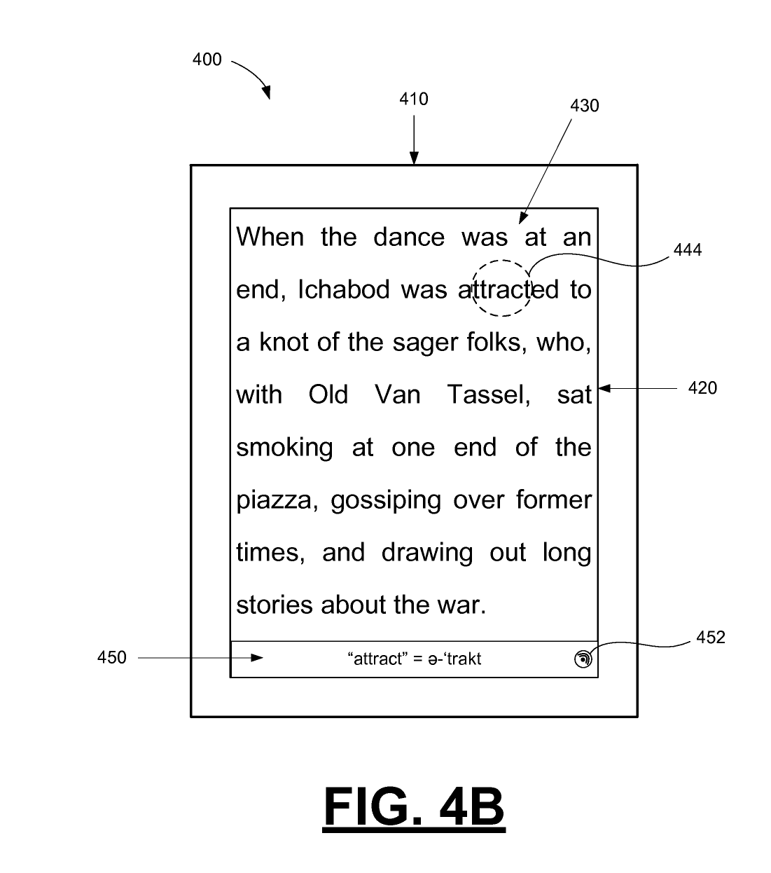

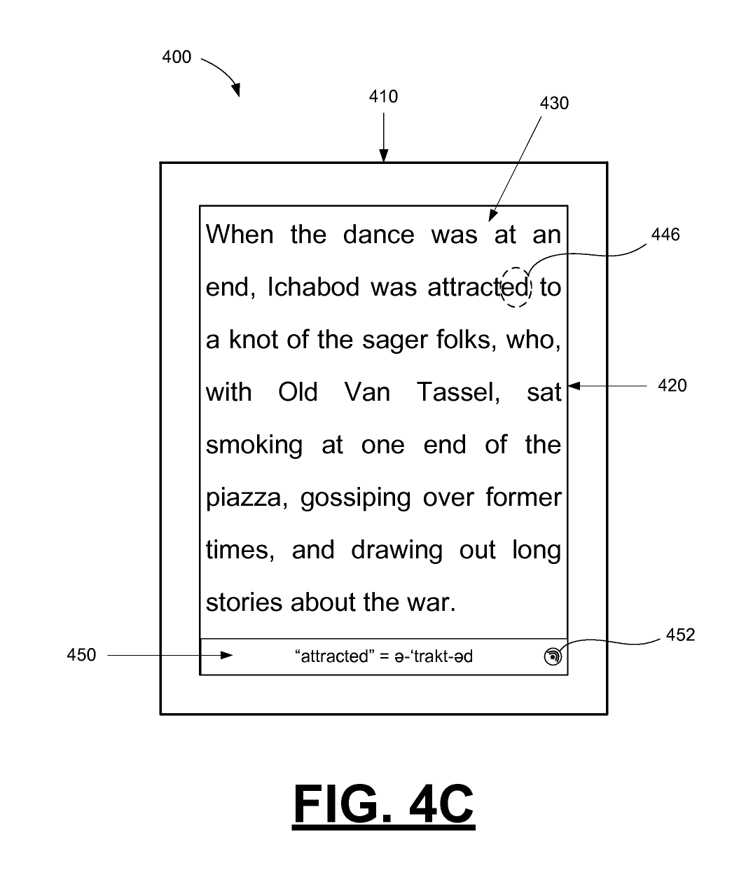

FIGS. 4A-4C illustrate embodiments of an e-reading device that responds to user input by providing syllabary content for one or more portions of a word associated with the user input. The e-reading device 400 includes a housing 410 and a display screen 420. The display screen 420 can be part of a display assembly, and can be touch sensitive. A touch sensing region 430 is provided with at least a portion of the display screen 420. For simplicity, the circuitry and/or hardware components 410-430 may be substantially similar, if not identical, in function to corresponding circuitry and hardware components 310-330 of the e-reading device 300 (e.g., as described above with respect to FIG. 3).

With reference to FIG. 4A, e-book content pertaining to an open e-book is displayed on the display screen 420. For some embodiments, the e-reading device 400 may respond to user input received via the touch sensing region 430 by displaying a pronunciation guide 450 on the display screen 420. More specifically, the pronunciation guide 450 may include syllabary content for a selected portion (e.g., syllable) of a word associated with the user input. For example, a user may select the first syllable of the word “attracted” by tapping and dragging his or her finger across the first letter (“a”) of the corresponding word. Alternatively, and/or in addition, the user may select the first syllable by tapping or double-tapping the portion of the word that coincides with the desired syllable. The e-reading device 400 may interpret this user input as a first syllabary selection input 442.

Upon detecting the first syllabary selection input 442, the e-reading device 400 may search a dictionary, using the underlying word (e.g., “attracted”) as a search term, for syllabary content associated with the selected syllable. For example, the search result may include a syllabary representation of the underlying word (“ [symbol] -'trakt- [symbol] d”) from which the e-reading device 400 may subsequently parse the syllabary content associated with the selected syllable (“ [symbol] ”). For some embodiments, the e-reading device 400 may also retrieve audio content including a pronunciation or vocalization of the selected syllable. For example, the user may tap an icon 452 provided in the pronunciation guide 450 to listen to an audible pronunciation of the selected syllable.

With reference to FIG. 4B, the user may then select another syllable of the underlying word (e.g., “attracted”), for example, by tapping and dragging his or her finger across the letters “t-t-r-a-c-t” of the corresponding word. Alternatively, and/or in addition, the user may select the next syllable of the underlying word by tapping or double-tapping the portion of the word that coincides with the aforementioned letters. Upon detecting another user input associated with the same underlying word, the e-reading device 400 may interpret such input as a second syllabary selection input 444. More specifically, upon detecting the second syllabary selection input 444, the e-reading device 400 may subsequently parse the syllabary content associated with the selected syllable (“trakt”) from the syllabary representation of the underlying word (“ [symbol] -'trakt-ad”), and display the new syllabary content together with the syllabary content from the previous selection (“ [symbol] -'trakt”). More specifically, the syllabary content for each syllable may be presented in the order in which the corresponding syllables appear in the underlying word. For some embodiments, the user may tap the icon 452 to listen to an audible pronunciation of both syllables strung together.

With reference to FIG. 4C, the user may subsequently select the final syllable of the underlying word (e.g., “attracted”), for example, by tapping and dragging his or her finger across the letters “e-d” of the corresponding word. Alternatively, and/or in addition, the user may select the final syllable of the underlying word by tapping or double-tapping the portion of the word that coincides with the aforementioned letters. Upon detecting another user input associated with the same underlying word, the e-reading device 400 may interpret such input as a third syllabary selection input 446. More specifically, upon detecting the third syllabary selection input 446, the e-reading device 400 may subsequently parse the syllabary content associated with the selected syllable (“ [symbol] d”) from the syllabary representation of the underlying word (“ [symbol] -'trakt-ad”), and display the new syllabary content together with the syllabary content from the previous two selections (“ [symbol] -'trakt-ad”). As described above, the syllbary content for each syllable may be presented in the order in which the corresponding syllables appear in the underlying word. For some embodiments, the user may tap the icon 452 to listen to an audible pronunciation of the underlying word, as a whole.

By allowing a user to select individual syllabic portions of an underlying word, the pronunciation guide 450 may assist the user in distinguishing between syllables that are spelled the same but pronounced differently. For example, the first syllable of “attract” coincides with the letter “a.” However, the pronunciation of “a” ( [symbol] ) in “attract” is very different than the pronunciation of letter “a” ('ā) as a standalone noun or indefinite article. Further, it should be noted that the layout and content of the pronunciation guide 450 of FIGS. 4A-4C are described and illustrated for exemplary purposes only. In certain implementations, the pronunciation guide 450 may include fewer or more features than those shown in FIGS. 4A-4C.

Pronunciation Guide Functionality

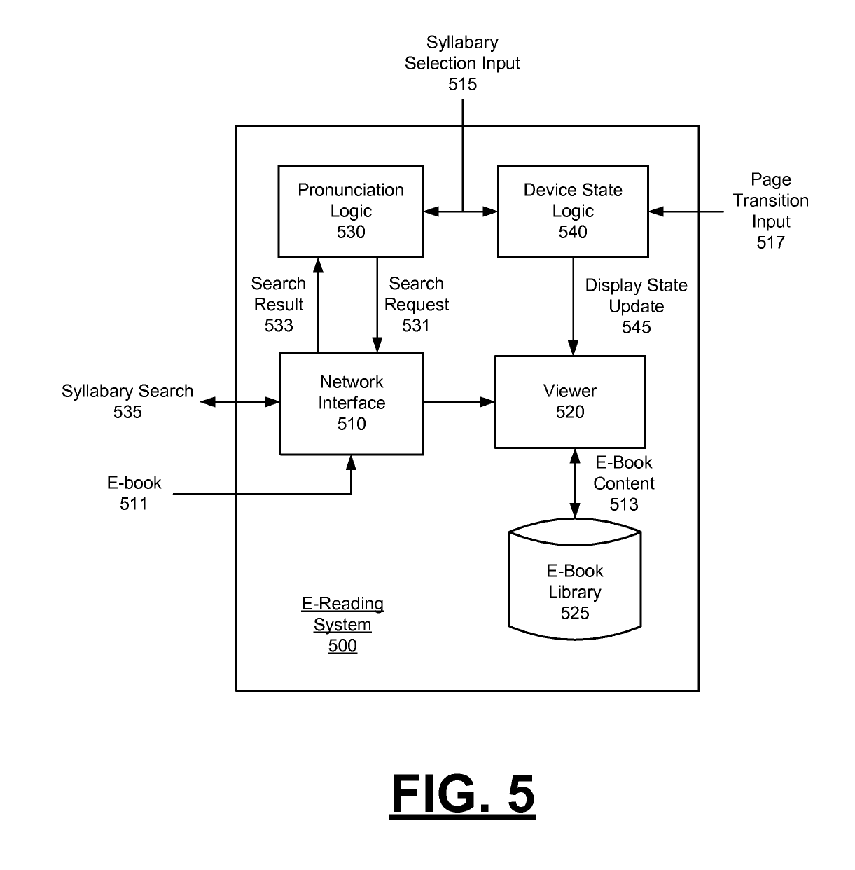

FIG. 5 illustrates an e-reading system 400 for displaying e-book content, according to one or more embodiments. An e-reading system 500 can be implemented as, for example, an application or device, using components that execute on, for example, an e-reading device such as shown with examples of FIGS. 1-3 and 4A-4C. Furthermore, an e-reading system 500 such as described can be implemented in a context such as shown by FIG. 1, and configured as described by an example of FIG. 2-3 and FIGS. 4A-4C.

In an example of FIG. 5, a system 500 includes a network interface 510, a viewer 520, pronunciation logic 530, and device state logic 540. As described with an example of FIG. 1, the network interface 510 can correspond to a programmatic component that communicates with a network service in order to receive data and programmatic resources. For example, the network interface 510 can receive an e-book 511 from the network service that the user purchases and/or downloads. E-books 511 can be stored as part of an e-book library 525 with memory resources of an e-reading device (e.g., see memory 250 of e-reading device 200).

The viewer 520 can access e-book content 513 from a selected e-book, provided with the e-book library 525. The e-book content 513 can correspond to one or more pages that comprise the selected e-book. Additionally, the e-book content 513 may correspond to portions of (e.g., selected sentences from) one or more pages of the selected e-book. The viewer 520 renders the e-book content 513 on a display screen at a given instance, based on a display state of the device 500. The display state rendered by the viewer 520 can correspond to a particular page, set of pages, or portions of one or more pages of the selected e-book that are displayed at a given moment.

The pronunciation logic 530 can retrieve syllabary content (e.g., from the network service 120 of FIG. 1) in response to receiving a syllabary selection input 515 associated with a particular word or syllable to be searched. For example, the syllabary selection input 515 may be provided by the user tapping on a region of a display of the e-reading system 500 that coincides with the identified word or syllable. The pronunciation logic 530 may generate a search request 531 based on the underlying word associated with the syllabary selection input 515. For example, the search request 531 may use the underlying word (e.g., “attracted”) as a search term regardless of the particular syllable(s) identified by the syllabary selection input 515 (e.g., “a,” “ttract,” and/or “ed”). The search request 531 is then sent (e.g., through the network interface 510) to an external dictionary (e.g., residing on the network service 120 of FIG. 1) to perform a syllabary search 513. For some embodiments, the dictionary may be a syllable-based audio-dictionary.

The network interface 510 may receive syllabary content associated with the underlying word in response to the syllabary search 513, and return a corresponding search result 533 to the pronunciation logic 530. More specifically, search result 533 may include any information needed to generate a pronunciation guide (e.g., as shown in FIGS. 3 and 4A-4C). For example, the search result 533 may include a syllabary representation of the underlying word associated with the syllabary selection input 515. For some embodiments, the search result 533 may also include audio content which may be used to generate an audible pronunciation or vocalization of the underlying word and/or portions thereof. The pronunciation logic 530 may further parse the search result 530 for syllabary content for one or more syllables specifically identified by the syllabary selection input 515.

The device state logic 540 can be provided as a feature or functionality of the viewer 520. Alternatively, the device state logic 540 can be provided as a plug-in or as independent functionality from the viewer 520. The device state logic 540 can signal display state updates 545 to the viewer 520. The display state update 545 can cause the viewer 520 to change or after its current display state. For example, the device state logic 540 may be responsive to page transition inputs 517 by signaling display state updates 545 corresponding to page transitions (e.g., single page transition, mufti-page transition, or chapter transition).

For some embodiments, the device state logic 540 may also be responsive to the syllabary selection input 515 by signaling a display state update 545 corresponding to the pronunciation guide (e.g., as shown in FIGS. 3 and 4A-4C). For example, upon detecting a syllabary selection input 515, the device state logic 540 may signal a display state update 545 causing the viewer 520 to display syllabary content from the search result 533 to the user. More specifically, the syllabary content may be formatted and/or otherwise presented as a pronunciation guide (e.g., as shown in FIGS. 3 and 4A-4C). For some embodiments, the viewer 520 may display only the syllabary content for one or more syllables specifically identified by the syllabary selection input 515. Further, for some embodiments, the e-reading system 500 may play back audio content including a pronunciation or vocalization of the selected word and/or syllable(s).

Methodology

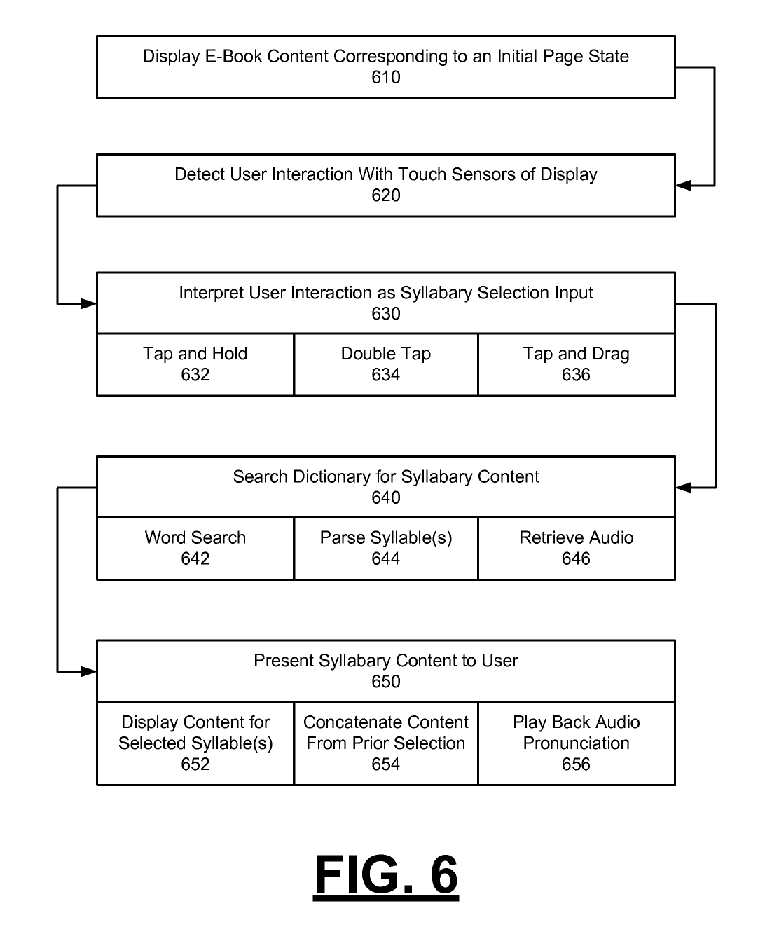

FIG. 6 illustrates a method of providing syllabary content for one or more portions of a word contained in an e-book being read by a user, according to one or more embodiments. In describing an example of FIG. 6, reference may be made to components such as described with FIGS. 2, 3 and 4A-4C for purposes of illustrating suitable components for performing a step or sub-step being described.

With reference to an example of FIG. 2, the e-reading device 200 may first display e-book content corresponding to an initial page state (610). For example, the device 200 may display a single page (or portions of multiple pages) of an e-book corresponding to the content being read by the user. Alternatively, the device 200 may display multiple pages side-by-side to reflect a display mode preference of the user. The e-reading device 200 may then detect a user interaction with one or more touch sensors provided (or otherwise associated) with the display 230 (620). For example, the processor 210 can receive inputs 231 from the touch sensor components 240.

The e-reading device 200 may interpret the user interaction as a syllabary selection input (630). More specifically, the processor 210, in executing the pronunciation logic 217, may associate the user interaction with a selection of a particular word or portion thereof (e.g., corresponding to one or more syllables) provided on the display 230. For some embodiments, the processor 210 may interpret a tap-and-hold input (632) as a syllabary selection input associated with a word or syllable coinciding with a touch sensing region of the display 230 being held. For other embodiments, the processor 210 may interpret a double-tap input (634) as a syllabary selection input associated with a word or syllable coinciding with a touch sensing region of the display 230 being tapped. Still further, for some embodiments, the processor 210 may interpret a tap-and-drag input (636) as a syllabary selection input associated with one or more syllables coinciding with one or more touch sensing regions of the display 230 being swiped.

The e-reading device 200 may then search a dictionary for syllabary content associated with the syllabary selection input (640). For some embodiments, the e-reading device 200 may perform a word search in a dictionary, using the underlying word associated with the syllabary selection input as a search term (642). For example, if the user selects the first syllable (“a”) of the word “attracted” as the syllabary selection input, the e-reading device 200 may use the underlying word (“attracted”) as the search term. More specifically, the processor 210, in executing the pronunciation logic 217, may send a search the dictionary 219 (or an external dictionary) for syllabary content associated with the underlying word. More specifically, the syllabary content may include a syllabary representation (e.g., comprising a string of phonemes) of the underlying word. For some embodiments, the processor 210 may further parse syllabary content for one or more selected syllables from the syllabary representation of the underlying word (644). For example, the parsed syllabary content may coincide with a string of phonemes that describe the pronunciation for the particular syllable(s) selected by the user (e.g., from the syllabary selection input). Still further, for some embodiments, the processor 210, in executing the pronunciation logic 217, may retrieve audio content which may be used to play back an audible pronunciation or vocalization of the selected syllable(s) and/or the underlying word (646).

Finally, the e-reading device 200 may present the syllabary content to the user (650). For example, the syllabary content may be presented in a pronunciation guide displayed on the display screen 230 (e.g., as described above with respect to FIGS. 3 and 4A-4C). For some embodiments, the processor 210, in executing the pronunciation logic 217, may display syllabary content for only the syllable(s) identified by the syllabary selection input (652). For example, if the user selects the first syllable (“a”) of the word “attracted,” the e-reading device 200 may display only the syllabary content for that syllable (“a”). Further, for some embodiments, the processor 210, in executing the pronunciation logic 217, may concatenate syllabary content from a prior syllabary selection input (654). For example, if after selecting the first syllable (“a”), the user subsequently selects the second syllable (“ttract”) of the word “attracted,” the e-reading device 200 may display syllabary content for the first and second syllables, together (“ [symbol] -'trakt”). Still further, for some embodiments, the processor 210, in executing the pronunciation logic 217, may play back audio content including a pronunciation or vocalization of the selected syllable(s) (656). For example, the processor 210 may play back the audio content in response to the syllabary selection input and/or in response to a separate audio playback input (e.g., by the user tapping a particular icon displayed in the pronunciation guide).

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a display assembly including a screen;
a housing that at least partially circumvents the screen so that the screen is viewable;
a set of touch sensors provided with the display assembly; and
a processor provided within the housing, the processor operating to:
display content pertaining to an e-book on the screen of the display assembly;
detect a first user interaction with the set of touch sensors;
interpret the first user interaction as a first user input corresponding with a selection of a first portion of an underlying word in the displayed content; and
display syllabary content for at least the first portion of the underlying word.

2. The computing device of claim 1, wherein the first portion of the underlying word comprises a string of one or more characters or symbols.

3. The computing device of claim 1, wherein the first portion coincides with one or more syllables of the underlying word.

4. The computing device of claim 3, wherein the processor is to further:
play back audio content including a pronunciation of the one or more syllables of the underlying word.

5. The computing device of claim 1, wherein the processor is to further:
search a dictionary using the underlying word as a search term; and
determine a syllabary representation of the underlying word based on a result of the search.

6. The computing device of claim 5, wherein the dictionary is a syllable-based audio dictionary.

7. The computing device of claim 5, wherein the processor is to further:
parse the syllabary content for the first portion of the underlying word from the syllabary representation of the underlying word.

8. The computing device of claim 1, wherein the processor is to further:
detect a second user interaction with the set of touch sensors;
interpret the second user interaction as a second user input corresponding with a selection of a second portion of the underlying word that is different than the first portion; and
display syllabary content for the second portion of the underlying word with the syllabary content for the first portion.

9. The computing device of claim 8, wherein the first portion coincides with a first syllable of the underlying word, and wherein the second portion coincides with a second syllable of the underlying word.

10. The computing device of claim 9, wherein the processor is to further:
play back audio content including a pronunciation of the first syllable and the second syllable, wherein the first and second syllables are pronounced in the order in which they appear in the underlying word.

11. A method for operating a computing device, the method being implemented by one or more processors and comprising:
displaying content pertaining to an e-book on a screen of a display assembly of the computing device;
detecting a first user interaction with a set of touch sensors provided with the display assembly;
interpreting the first user interaction as a first user input corresponding with a selection of a first portion of an underlying word in the displayed content;
displaying syllabary content for at least the first portion of the underlying word.

12. The method of claim 11, wherein the first portion coincides with one or more syllables of the underlying word.

13. The method of claim 12, further comprising:
playing back audio content including a pronunciation of the one or more syllables of the underlying word.

14. The method of claim 11, further comprising:
searching a dictionary using the underlying word as a search term; and
determining a syllabary representation of the underlying word based on a result of the search.

15. The method of claim 14, wherein the dictionary is a syllable-based audio dictionary.

16. The method of claim 14, further comprising:
parsing the syllabary content for the first portion of the underlying word from the syllabary representation of the underlying word.

17. The method of claim 11, further comprising:
detecting a second user interaction with the set of touch sensors;
interpreting the second user interaction as a second user input corresponding with a selection of a second portion of the underlying word that is different than the first portion; and
displaying syllabary content for the second portion of the underlying word with the syllbary content for the first portion.

18. The method of claim 17, wherein the first portion coincides with a first syllable of the underlying word, and wherein the second portion coincides with a second syllable of the underlying word.

19. The method of claim 18, further comprising:
playing back audio content including a pronunciation of the first syllable and the second syllable, wherein the first and second syllables are pronounced in the order in which they appear in the underlying word.

20. A non-transitory computer-readable medium that stores instructions, that when executed by one or more processors, cause the one or more processors to perform operations that include:
displaying content pertaining to an e-book on a screen of a display assembly of the computing device;
detecting a first user interaction with a set of touch sensors provided with the display assembly;
interpreting the first user interaction as a first user input corresponding with a selection of a first portion of an underlying word in the displayed content;
displaying syllabary content for at least the first portion of the underlying word.
